(19) United States
(12) Patent Application Publication
(10) Pub. No.: US 2021/0022409 A1
(43) Pub. Date: Jan. 28, 2021

(54) MULTIPLE VOLTAGE VAPING DEVICE

(71) Applicant: DC 86 LLC, Los Angeles, CA (US)

(72) Inventors: David CHIA, Los Angeles, CA (US); Kevin CHUNG, Los Angeles, CA (US); Jimmy FUNG, Los Angeles, CA (US)

(21) Appl. No.: 16/518,138

(22) Filed: Jul. 22, 2019

(51) Int. Cl. A24F 47/00; H05B 1/02; H02J 7/00

(52) U.S. Cl. CPC A24F 47/008; H02J 2007/0062; H02J 7/0052; H05B 1/0247

(57) ABSTRACT

A vaping device has a rechargeable battery providing a voltage to an inserted removable cartridge. The cartridge contains a chemical solution that generates an aerosol upon an increase in temperature. A mode switch allows selection between two voltages, in turn allowing selection of two different temperatures.

### TECHNICAL FIELD

The present disclosure relates to vaping devices. More particularly, it relates to a multiple voltage vaping device.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIGS. 1-9 illustrate different perspective views of the vaping device.

FIG. 10 illustrates schematic views showing internal and external components.

FIG. 11 illustrates the slot that accepts the cartridges.

### SUMMARY

In a first aspect of the disclosure, a method is described, the method comprising: a battery; two electrodes electrically connected to the battery; an air flow sensor configured to sense air flow and send an activation signal; a mode switch configured to select between a first voltage difference between the two electrodes and a second voltage difference between the two electrodes, the second voltage difference being higher than the first voltage difference; a printed circuit board configured to activate the first or second voltage difference between the two electrodes, upon receiving the activation signal from the air flow sensor, and based on a position of the mode switch, a slot configured to accept insertion of a removable cartridge, wherein the insertion comprises electrically contacting the two electrodes to a heater within the removable cartridge

### DETAILED DESCRIPTION

The present disclosure describes a vaping device. The device is powered by a battery and activated by an airflow sensor. When the device detects suction, the rechargeable battery provides a voltage to the heating element, which in turn generates an aerosol from a cartridge containing a chemical solution. The chemical solution can contain compounds that, when inhaled, alter the state of consciousness of an individual, for example based on marijuana.

The device contains an electronic module that that vary the voltage provided by the battery to the heating element. A switch on the device allows the user to select between two or more voltage levels. Some cartridges available commercially are best operated at one voltage, while others may operate optimally at other voltages. The solution contained in the cartridge may require different temperatures to generate an aerosol. The switch allows the user to select the voltage, and in turn the temperature, at which the device operates, depending on what type of cartridge or solution is used. For example, the switch may allow the user to select between three different voltages, four different voltages, or even more voltage levels.

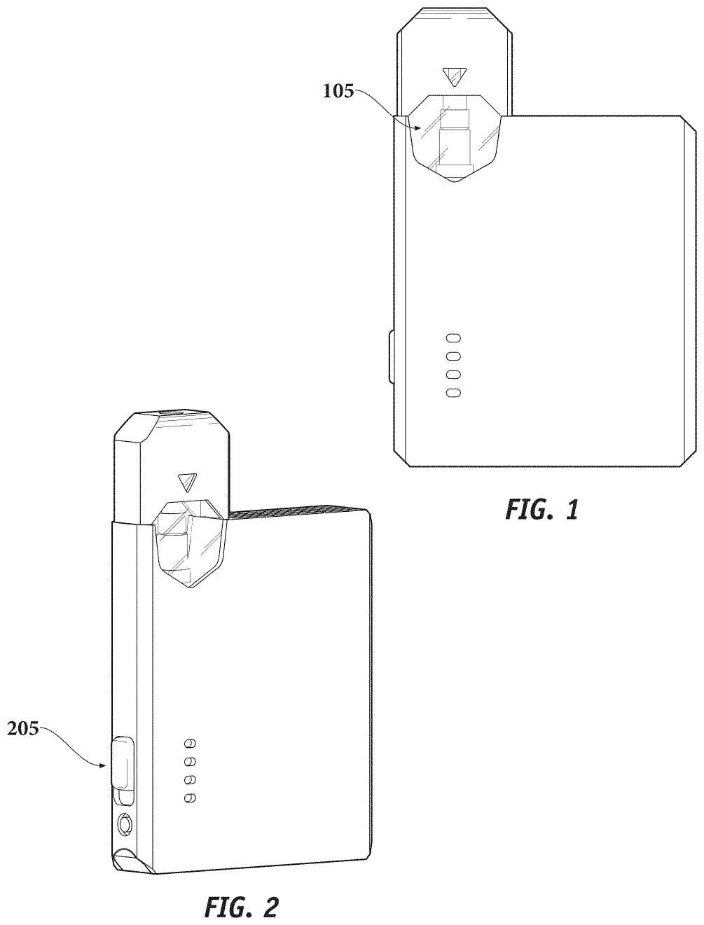

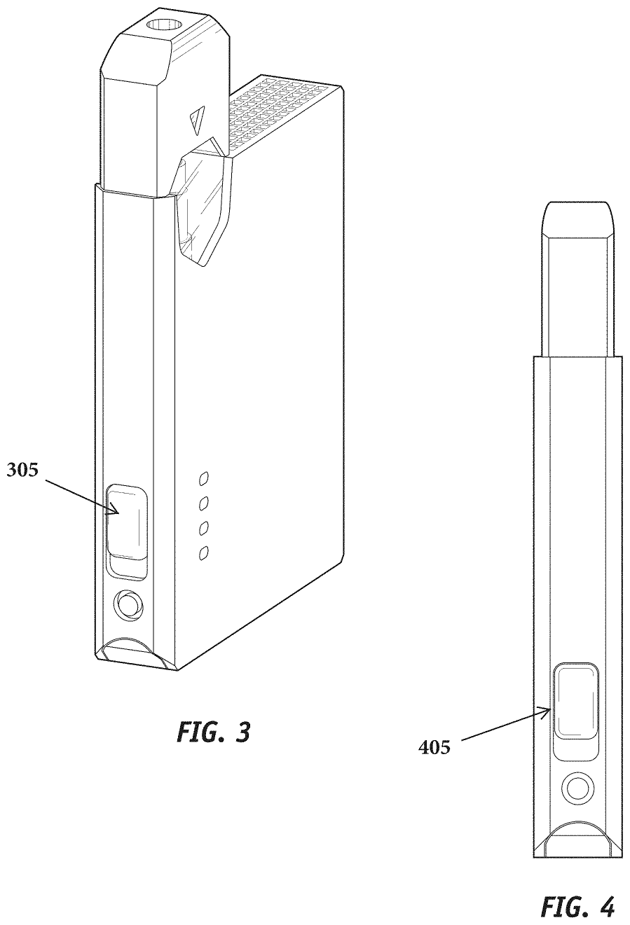

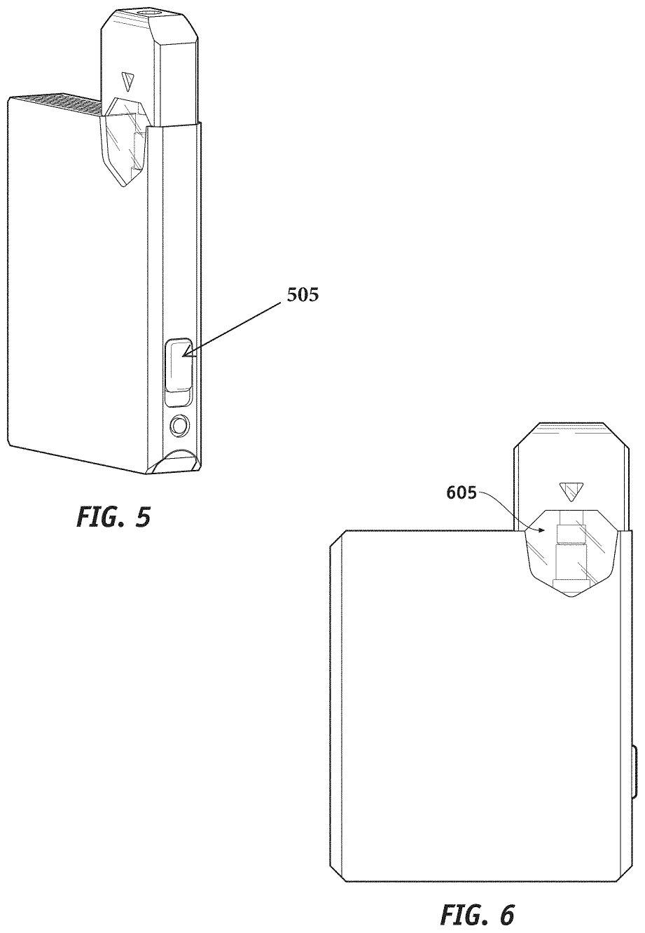

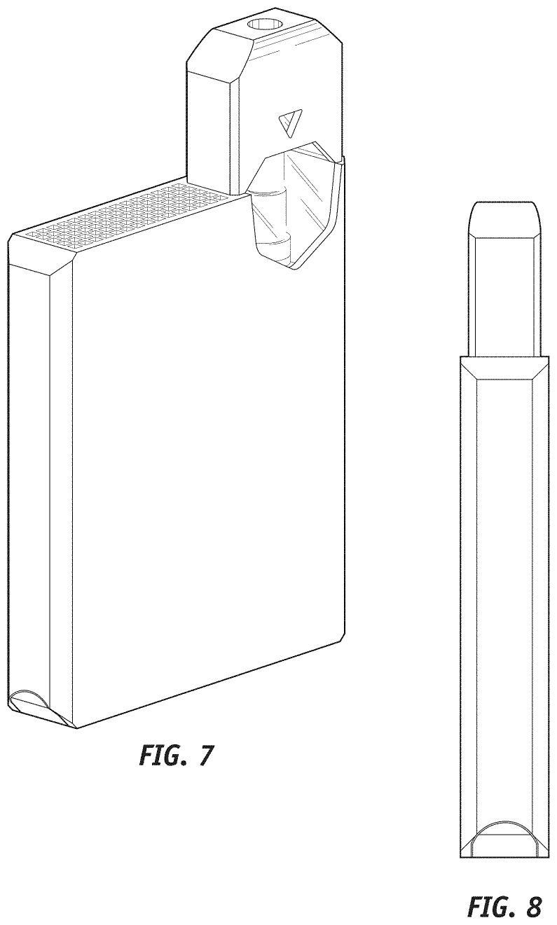

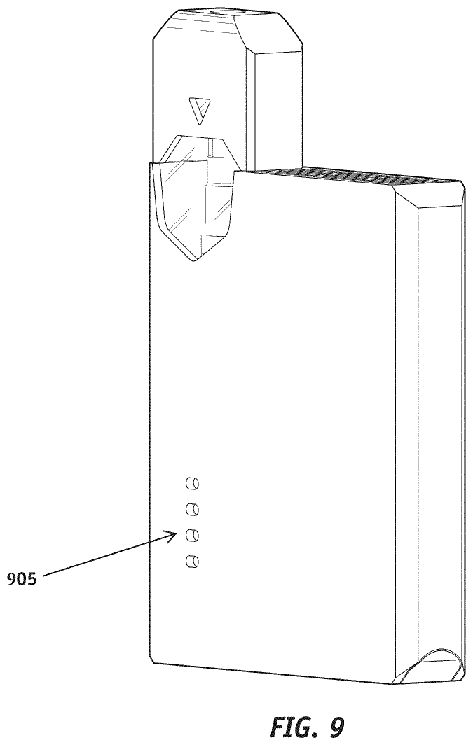

The specific shape, in the device, of the slot that accepts a removable cartridge is chosen so as to ensure compatibility with specific cartridges. The shape of the slot is shown in FIG. 1. FIG. 2 illustrates the switch that allows the voltage selection, depending on whether the switch is in the up or down position. The switch of FIG. 2 slides up and down and can be operated by a finger, for example by a thumb. FIGS. 1-9 illustrate different views of the same device. In FIG. 1, the cartridge is inserted in the device (105); a similar view is visible in FIG. 6 (605). The voltage mode selector switch is visible in FIG. 2 (205), FIG. 3 (305), FIG. 4 (405), FIG. 5 (505). The LEDs are visible in FIG. 9 (905).

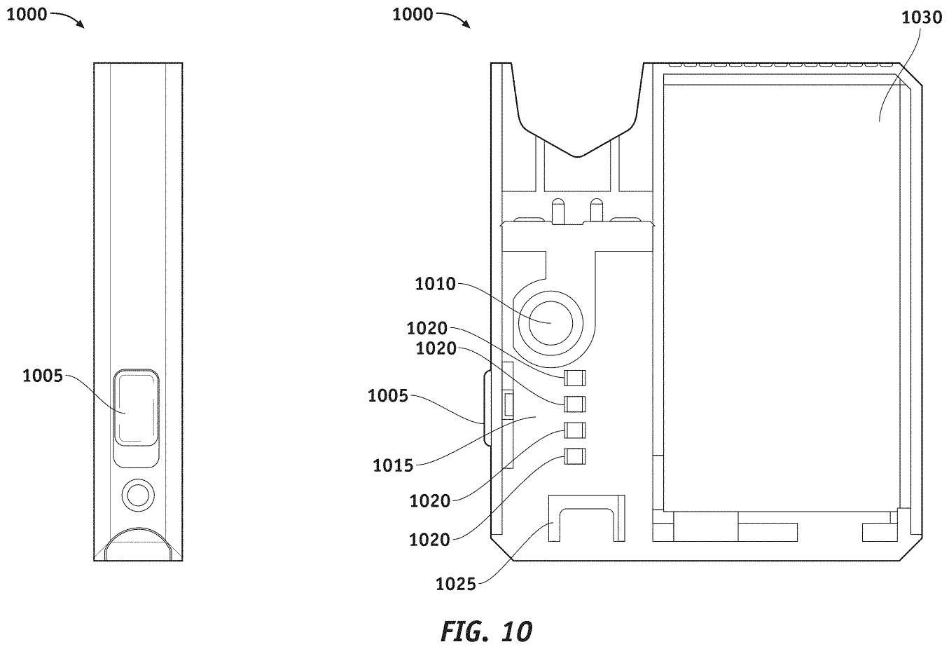

FIG. 10 illustrates internal components of the device (1000), in particular the battery (1030), the airflow sensor (1010), the LEDs (1020), the micro USB port (1025), the mode switch (1005), and the PCB (1015) that controls the device operation. The micro USB port allows charging of the battery, for example by a USB charger. The USB port may also use other standards, for example USB ports that are smaller and more recent than the micro USB port. FIG. 10 also illustrates the two electrodes that are set at the specified voltage by the battery, and provide the electric voltage to operate the heating element inside the removable cartridge. As the air flow sensor detects suction by a user, it sends an activation signal to the PCB, which in turn sets the voltage between the two electrodes connected to the heater.

In some embodiments, the LEDs can display information about the device's operation. For example, the number of LEDs lit may indicate the battery level of the device. For example, if the device has four LEDs, the battery may be full when all four all lit; the number of lit LEDs decreases when the battery level decreases, with one LED indicating a low battery state. When the device is being charged, the LEDs may animate by lighting in sequence, with only one LED lit, then two, then three, then four, and subsequently down to three, two and one. The color of the LEDs may indicate the voltage selected. If the LEDs are blue, for example, a low voltage is selected, while if the LEDs are green, a higher voltage is selected. Multiple colors may allow display of different voltage levels.

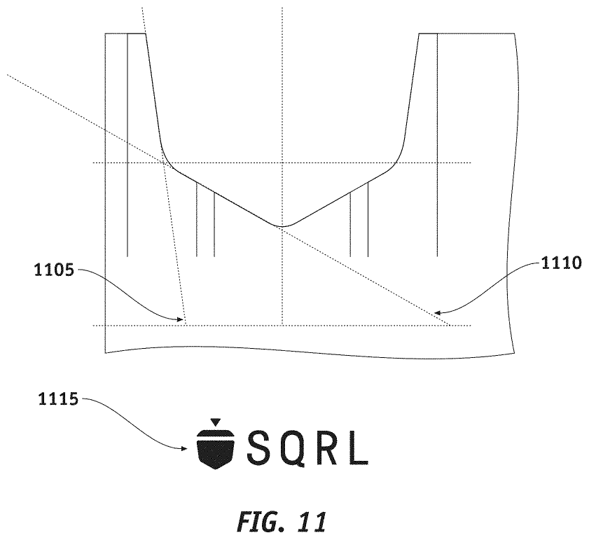

FIG. 11 illustrates a close up view of the slot that accepts the cartridges, with its shape being similar to the logo that is imprinted on a surface of the device. The shape is symmetrical and defined by a first angle (1110) between 90° and 180°, and a second angle also between 90° and 180°, the second angle being smaller than the first angle. In FIG. 11, the angles are defined relative to the horizontal line of the device, orthogonal to the longitudinal axis of the device. These two angles symmetrically define a shape that is proportionally congruent to the lower part of the logo (1115). When a cartridge is attached to the device, the full logo shape becomes visible as in FIG. 6 (605). In fact, the cartridge defines the top part of the logo shape.

The examples set forth above are provided to those of ordinary skill in the art as a complete disclosure and description of how to make and use the embodiments of the disclosure, and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

What is claimed is:

1. A device comprising:
a battery;
two electrodes electrically connected to the battery;
an air flow sensor configured to sense air flow and send an activation signal;
a mode switch configured to select between a first voltage difference between the two electrodes and a second voltage difference between the two electrodes, the second voltage difference being higher than the first voltage difference;
a printed circuit board configured to activate the first or second voltage difference between the two electrodes, upon receiving the activation signal from the air flow sensor, and based on a position of the mode switch,
a slot configured to accept insertion of a removable cartridge, wherein the insertion comprises electrically contacting the two electrodes to a heater within the removable cartridge.

2. The device of claim 1, further comprising a USB port configured to charge the battery.

3. The device of claim 1, further comprising a plurality of LEDs configured to display a first color when the first voltage difference is selected, and a second color different from the first color, when the second voltage difference is selected.

4. The device of claim 1, wherein the slot has a symmetrical polygonal shape comprising a first angle between 90° and 180°, and a second angle between 90° and 180°, the second angle being smaller than the first angle.

5. The device of claim 1, wherein the mode switch is further configured to select between the first voltage difference, the second voltage difference, and a third voltage difference, the third voltage difference being higher than the second voltage difference.

6. The device of claim 1, wherein the mode switch is further configured to select between a plurality of voltage differences.
